(19) United States
(12) Patent Application Publication
(10) Pub. No.: US 2026/0285224 A1
(43) Pub. Date: Sep. 24, 2026

(54) Method for Activating a Light-Emitting Textile for a Trim Part of a Vehicle

(71) Applicant: Bayerische Motoren Werke Aktiengesellschaft, Muenchen (DE)

(72) Inventor: Fredrik SVEDBERG, Muenchen (DE)

(21) Appl. No.: 19/475,502

(22) PCT Filed: Mar. 28, 2024
(86) PCT No.: PCT/DE2024/100264

§ 371 Date: Oct. 15, 2025

(30) Foreign Application Priority Data
Apr. 26, 2023 (DE) 10 2023 110 715.1

(51) Int. Cl. B60Q 3/64; B60Q 3/20; B60R 13/02; F21V 8/00

(52) U.S. Cl. CPC B60Q 3/64; B23K 26/0622; B23K 26/402; B60Q 3/217; B60R 13/02; D03D 15/547; G02B 6/001

(57) ABSTRACT

A method for activating a light-emitting textile includes providing a light-emitting textile having a textile layer which comprises at least one light guide having a casing, and producing at least one light exit region by irradiating at least a portion of the casing of the light guide with a first energy beam and a second energy beam.

### BACKGROUND AND SUMMARY

The present disclosure relates to a method for activating a light-emitting textile for a trim part of a vehicle, a trim part and a vehicle.

For aesthetic reasons, the interior of a vehicle can be provided with trim parts made from a textile layer into which light guides are incorporated. Such a textile is also referred to as a light-emitting textile and is suitable for creating ambient light. The light guides illuminate the textile, creating an additional optical effect in the interior. The light guides are woven into the textile, bundled, and connected to a light source, such as an LED module.

The light source couples light into each individual light guide, and the light travels axially within the light guide, similar to glass fibers. The visible light in the textile exits radially from the light guides. The light can exit the light guide in two different ways. In the case of the first variant, the light is emitted in the radial direction along the entire length of the fiber. Such light guides are referred to as “side-emitting fibres.”

An example of a light-emitting textile with “side-emitting fibres” is disclosed in DE 10 2013 202 715 A1. The light-emitting textile consists of at least one layer of warp and weft threads, with at least one light source coupling light into the front of the luminous textile, and the light exiting the luminous textile at an angle to the longitudinal extent of the light-guiding element, for example, the thread, wherein a light output coupling structure for more targeted reflection of the light consists of distributed reflector elements that are adhesively connected to the light-guiding elements, for example, the threads, of the luminous textile on at least one side of the surface of the luminous textile.

In a second variant, the light guide has a casing, referred to as “cladding” which prevents light from escaping in the radial direction along the length of the light guide. Only regions where the coating has been removed or damaged are excluded. DE 10 2016 207 693 A1 discloses in this regard a method for producing a trim part for a vehicle. During the production of the trim part, a plurality of light guides are woven into a fibrous decorative layer. In certain decorative areas, material from the fibrous decorative layer is then removed from the surface. Fibers of the fibrous decorative layer are thereby removed from the surface, and the light guides are slightly and intentionally damaged, resulting in edge-emitting sections. This method step is also generally referred to as activation. Light coupled into the light guides can then exit from the edge-emitting sections, thus illuminating the luminous decoration.

Generally, two methods for activating the light guide are known, namely by sandblasting or by laser. Activation by sandblasting is disclosed, for example, in DE 10 2020 108 869 A1.

A method for activation by a laser is known from DE 10 2017 215 369 A1. The laser creates discontinuities or irregularities in the surface material of the light guide. Light can be emitted through these discontinuities or irregularities. However, in the case of such a method, the energy is directed onto the surface by a single laser beam to create irregularities. This damages not only the light guide but also the warp threads of the textile.

DE 102018 111 072 A1 discloses another method for activation by a laser. In this case, the laser is moved along a defined path across the visible side of the decorative material, which has light guides. As the laser beam moves along the path, material is removed point-by-point at the predefined locations.

DE 10 2017 197 935 A1 discloses the use of a laser beam for removing woven material from leather. Although DE 10 2017 197 935 A1 also discloses a second laser, this is only used to measure the thickness and not to remove material.

A disadvantage of the known methods for activation by a laser is that the entire energy density for activation is transferred to the surface of the light-emitting textile by a single laser beam. This, however, damages not only the light guide but also the surrounding textile fibers.

An object on which the present disclosure is based is to enable gentle activation.

To achieve this object, a method, a trim part and a vehicle with the features disclosed herein are proposed.

Advantageous configurations of the method, the trim part and the vehicle are also the subject matter of the present disclosure.

According to a first aspect of the present disclosure, a method for activating a light-emitting textile is proposed, which has the following steps: a) providing a light-emitting textile with a textile layer which has at least one light guide, wherein the light guide is surrounded by a casing, and b) creating at least one light exit region by irradiating at least a partial region of the casing of the light guide with a first energy beam and a second energy beam.

Such a method is characterized, for example, as a gentle method, by virtue of the fact that the energy density, which is required for activation, of the respective energy beams is irradiated by at least two energy beams onto the region to be activated. Only in the region where the energy beams overlap and form an intersection is sufficient energy available to, for example, heat the casing to such an extent that it is removed and/or damaged. Damage is understood, in particular, to mean that the casing is only partially removed or the casing is roughened, so that the light introduced into the light guide can emit from the damaged partial region. Due to the fact that the respective energy beam itself has a lower energy density than that required to damage or remove the casing of the light guide, no or only minimal damage is caused in the region of the light-emitting textile irradiated by the energy beam alone. Consequently, for example, the polyester fiber (PES) warp threads adjacent to the light guides are also not damaged or are only slightly damaged, so that the proposed method results in gentle activation.

For example, a casing should be understood as a layer that is almost light-impermeable. Energy density should be understood as the energy per unit area. This is also referred to as fluence. Energy is the potential energy stored in the electromagnetic radiation.

Preferably, the light guide is irradiated synchronously with the first energy beam and the second energy beam. Thus, the partial region is irradiated simultaneously with both the first energy beam and the second energy beam.

Preferably, the two energy beams intersect at an intersection point, with the two energy beams enclosing an angle at the intersection point, and with the angle being greater than zero. The angle is not zero, since the two energy beams are emitted from two different positions onto the intersection point, which may be located on the surface of the textile. However, the angle itself is variable, since the positions from which the energy beams are emitted are, for example, fixed mirrors that direct the energy beam onto the region to be activated, onto the fixed textile layer. The intersection point can also mean an area in which, however, both energy beams overlap.

In one advantageous embodiment, the first energy beam has a first energy density and the second energy beam has a second energy density, wherein the sum of the first energy density and the second energy density is suitable for creating a light exit region. In one advantageous configuration, the first and second energy densities alone are not sufficient to create a light exit region. It should be noted that the energy densities here are only suitable in sum for activation at the intersection point.

In one advantageous configuration, the first energy beam and/or the second energy beam is/are guided over a surface of the textile layer in a predefined path. This enables a particularly simple method.

In one advantageous development of the method, at least a third energy beam is provided, which has a third energy density, wherein the sum of the first energy density, the second energy density, and the third energy density is suitable for creating a light exit region. In this case, the energy density of the individual energy beams can be further reduced, thereby enabling an even gentler activation method.

In one advantageous configuration, the light guide has a first light entry surface and/or a second light entry surface, wherein the second energy beam and/or the third energy beam is/are introduced into the light guide via the first light entry surface and/or the second light entry surface. This results in particularly gentle activation. In contrast to activation by two energy beams, both directed at the surface of the textile layer, in this configuration only the first energy beam is directed at the surface, in particular guided over the surface along a path. The second energy beam and/or the third energy beam, however, is/are introduced via the light guides. Consequently, the energy density of the first and/or the second energy beam is present in the light guide. However, the sum of the second and third energy densities is not sufficient to damage the casing. Only through the additional energy density of the first energy beam on the surface of the light-emitting textile can a light exit region be created in the overlapping partial region of the first energy beam together with the second energy beam and/or the third energy beam. This method enables particularly gentle activation, as there is little or no unwanted damage to the textile threads surrounding the light guides in the light-emitting textile.

Preferably, the first energy beam and/or the second energy beam and/or the third energy beam is/are a laser beam, in particular a pulsed laser beam. A laser beam is particularly suitable for applying energy to generate heat in a targeted manner to a partial region of a surface to be activated.

The energy beam can be, for example, a UV laser with a wavelength of between 320 and 400 nm. The laser can, for example, have a pulse frequency of up to 120 kHz.

A further aspect of the present disclosure relates to a trim part for a vehicle, which comprises at least one light-emitting textile with a textile layer, which has at least one light guide with a casing, wherein at least one light exit region is created with a method described above.

The textile layer can have warp threads and weft threads that are interwoven. At least one weft thread is advantageously a light guide. Furthermore, a plurality of weft threads are advantageous.

The light guide is preferably made of polymethyl methacrylate (PMMA). Such a light guide is particularly suitable as a weft thread, as the material properties of PMMA enable a light guide which is formed to be particularly movable. The warp thread is preferably made of polyester fiber (PES).

A further aspect of the present disclosure relates to a vehicle having at least one trim part as described above.

In the following, a vehicle, a trim part and a method for activating a surface of a light-emitting textile as well as further features and advantages are explained in greater detail on the basis of exemplary embodiments that are schematically represented in the figures.

### BRIEF DESCRIPTION OF THE DRAWINGS

FIG. 1 shows a vehicle having a vehicle door;

FIG. 2 shows an enlarged interior view of the vehicle door with a trim part;

FIG. 3 shows a front view of the light-emitting textile for a trim part with woven-in light guides;

FIG. 4 shows an enlarged cross-section through the light-emitting textile with at least one woven-in light guide;

FIG. 5 shows a light-emitting module connected to a light guide for introducing light;

FIG. 6 shows an enlarged cross-section through the light guide of FIG. 3 with light exit regions;

FIG. 7 shows a woven textile layer with light guides;

FIG. 8 shows the method according to the present disclosure in a first embodiment variant;

FIG. 9 shows the method according to the present disclosure in a second embodiment variant; and

FIG. 10 shows the method according to the present disclosure in a third embodiment variant.

### DETAILED DESCRIPTION OF THE DRAWINGS

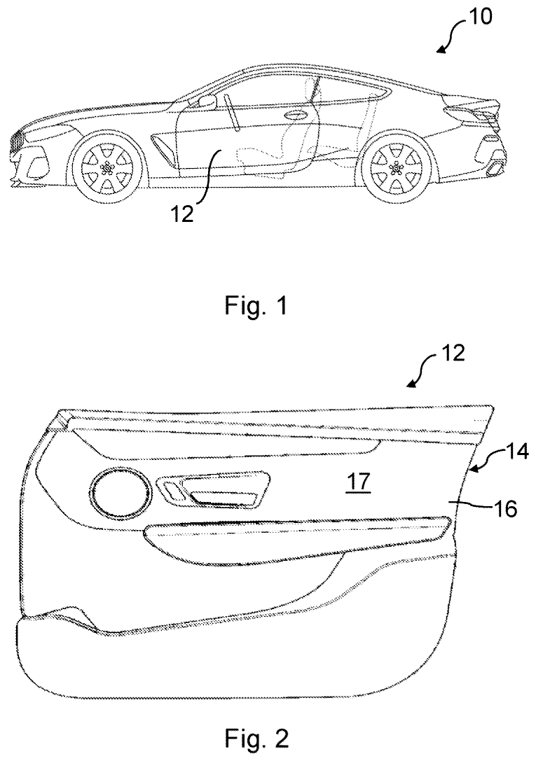

FIG. 1 shows a vehicle 10 with a vehicle door 12. The vehicle 10 has a drive machine formed as an internal combustion engine and/or as an electric motor.

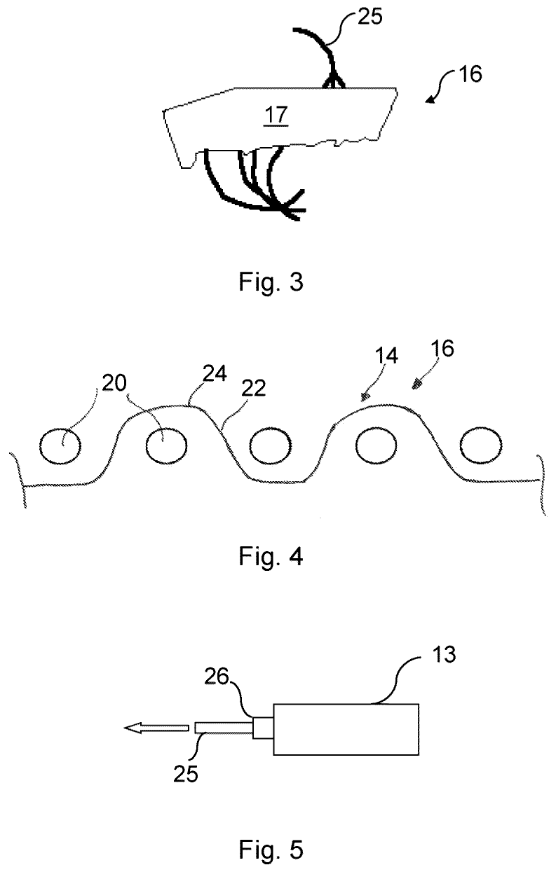

The vehicle door 12 has a trim part 14 represented in FIG. 2 with a light-emitting textile 16. The light-emitting textile 16 without the trim part 14 is shown in FIG. 3. The light-emitting textile 16 has a surface 17 which, in an installed position of the trim part 14, faces an inner side of a vehicle interior.

The light-emitting textile 16 has a textile layer 18 formed from interwoven warp threads 20 and weft threads 22. A cross-section through the light-emitting textile 16 is shown in FIG. 4. One of the weft threads 22 or several of the weft threads 22 of the light-emitting textile 16 is/are, for example, light guides 24, which can generate a light image when woven in. In an alternative configuration of the light-emitting textile, it is conceivable that the light guides 24 are also woven into the textile layer as warp threads 20 or as warp threads 20 and as weft threads 22. The light image can be created by activating partial regions of the light guide 24, as described below.

The light guides 24 are led out of the light-emitting textile 16 and combined into a bundle comprising 40 to 80 light guides 24 to form a tentacle 25. One end of the tentacle 25 terminates in a ferrule 26. The ferrule 26 is comparable to a wire end, but can be connected to a light module 13 for coupling light into the light guide 24, as shown in FIG. 5. The light module 13 is, for example, an LED light source and serves to illuminate the light-emitting textile 16 via the light guides 24.

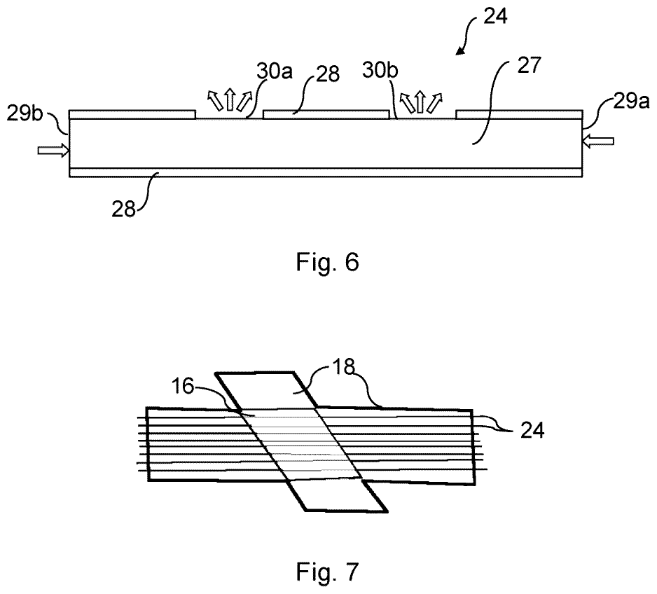

FIG. 6 shows a cross-section through the light guide 24 in the region of the light textile 16. The light guide 24 has a light channel 27, in which light is introduced into the light guides 24 via a first light entry surface 29a and/or a second light entry surface 29b via the light module 13. The light is schematically visualized in FIG. 5 and FIG. 6 by an arrow.

The light channel 27 is surrounded by a casing 28 that encloses the light channel 27 and can be referred to as “cladding”. By removing and/or damaging the casing 28 in certain areas by energy beams 51, 52, 53, in particular laser beams, first and second light exit regions 30a, 30b, which can also be referred to as activated surfaces, are created. During removal and/or damage, the coating is, for example, only partially removed, thereby roughening the surface of the casing 28. Alternatively, the casing 28 is completely removed and/or the surface of the light channel 27 is damaged or roughened. In the region of the first and second light exit regions 30a, 30b, the light coupled into the light channel 26 exits diffusely from the light guide 24, as schematically represented by the arrows in FIG. 6.

FIG. 7 to FIG. 10 show the method according to the present disclosure for activating the light-emitting textile 16. FIG. 7 shows the provided light-emitting textile 16. At this point in time, the light-emitting textile 16 may still be in a so-called delivery state, in which the light guides 24 are still completely woven into the textile layer 18. Only then are the light guides 24 partially removed from the textile layer 18 and combined into tentacles 25. The unused textile layer 18 is separated and removed. In an alternative configuration of the method, the light-emitting textile 16 is provided after the previously described processing steps.

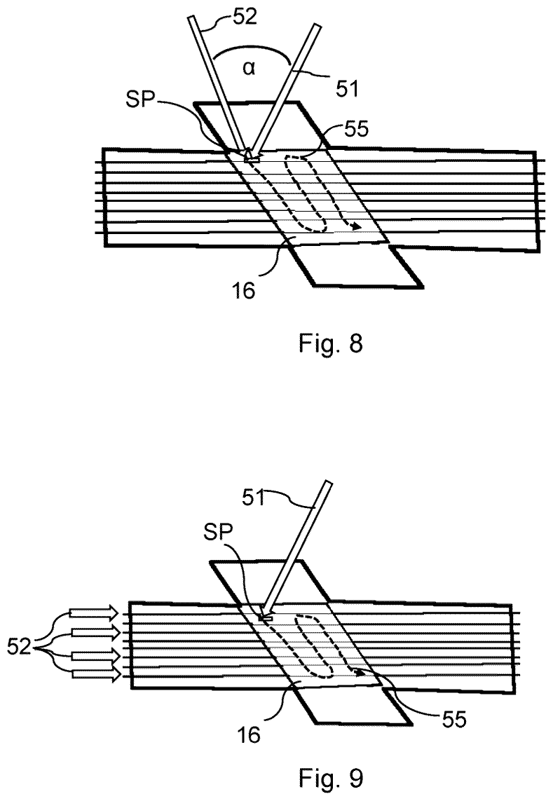

FIG. 8 shows a first embodiment variant. In this method, a region on the surface 17 is activated with a first energy beam 51 and a second energy beam 52. The overlapping region of the first energy beam 51 and the second energy beam 52 forms the intersection point SP. The first energy beam 51 has a first energy density, and the second energy beam 53 has a second energy density. The sum of the first energy density and the second energy density is sufficient to activate the partial region 56. Furthermore, the first energy beam 51 is planar, and the second energy beam 52 is point-shaped. The surface irradiated by the second energy beam 52 is significantly smaller than the surface irradiated by the first energy beam 51. For example, the surface area of the region irradiated by the second energy beam 52 corresponds to less than half the surface area of the region irradiated by the first energy beam 51, preferably only one tenth, and more preferably only one hundredth.

The angle α between the first energy beam 51 and the second energy beam 52 is not equal to zero. Furthermore, the angle α varies depending on the position of the surface to be activated. For activation, the first energy beam 51 and the second energy beam 52 are guided along a path 55 over the surface to be activated.

The second embodiment of the method according to the present disclosure is shown in FIG. 9. In contrast to the first embodiment, the second energy beam 52 is coupled into the light guide 24, for example, via the first light entry surface 29a. Only the first energy beam 51 is guided along a path 55 over the surface of the light-emitting textile 16. The sum of the first energy density and the second energy density at the intersection point SP is suitable for activating the partial region of the casing 28 in such a way that a light exit region 30a, 30b is created in this partial region.

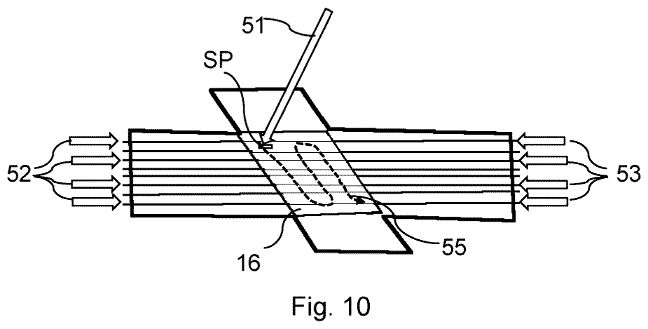

A further preferred formation of the second embodiment is shown in FIG. 10. In this method, a third energy beam 53 with a third energy density is additionally coupled into the light guide 24 via the second light entry surface 29b. The sum of the first energy density, the second energy density, and the third energy density is suitable in the overlapping region, which is the previously described intersection point SP, for activating the casing 28 such that a light exit region 30a, 30b is created.

The method is characterized in that the warp threads, which consist, for example, of polyester fibers (PES), are not damaged to the same extent as if the energy density required for activation were applied to the surface by a single energy beam. In particular, the second and third embodiments of the method represent a particularly gentle and preferred embodiment of the method for activating a light-emitting textile 16.

### LIST OF REFERENCE SIGNS

10 Vehicle
12 Vehicle door
13 Light-emitting module
14 Trim part
16 Light-emitting textile
17 Surface
18 Textile layer
20 Warp thread
22 Weft thread
24 Light guide
25 Tentacle
26 Ferrule
27 Light channel
28 Casing
29a First light entry surface
29b Second light entry surface
30a First light exit region
30b Second light exit region
51 First energy beam
52 Second energy beam
53 Third energy beam
55 Path
SP Intersection point
α Angle

1-10. (canceled)

11. A method for activating a light-emitting textile comprising:
providing a light-emitting textile with a textile layer that has at least one light guide with a casing; and
creating at least one light exit region by irradiating at least a partial region of the casing of the light guide with a first energy beam and a second energy beam.

12. The method according to claim 11, comprising:
irradiating the partial region of the casing of the light guide synchronously with the first energy beam and the second energy beam.

13. The method according to claim 11,
wherein the first energy beam and the second energy beam intersect at an intersection point, and wherein the first energy beam and the second energy beam enclose an angle at the intersection point, the angle being greater than zero.

14. The method according to claim 11,
wherein the first energy beam has a first energy density and the second energy beam has a second energy density, wherein a sum of the first energy density and the second energy density is suitable for creating the light exit region.

15. The method according to claim 14, comprising:
providing at least one third energy beam having a third energy density, wherein a sum of a first energy density of the first energy beam, a second energy density of the second energy beam, and the third energy density is suitable for creating the light exit region.

16. The method according to claim 11, comprising:
guiding the first energy beam and/or the second energy beam over a surface of the light-emitting textile in a predefined path.

17. The method according to claim 16, comprising:
providing at least one third energy beam having a third energy density, wherein a sum of the first energy density, the second energy density and the third energy density is suitable for creating the light exit region.

18. The method according to claim 17,
wherein the first energy beam and/or the second energy beam and/or the third energy beam is/are a laser beam.

19. The method according to claim 11,
wherein the light guide has a first light entry surface and/or a second light entry surface,
wherein the second energy beam and/or a third energy beam is/are introduced into the light guide via the first light entry surface and/or the second light entry surface.

20. The method according to claim 19,
wherein the first energy beam and/or the second energy beam and/or the third energy beam is/are a laser beam.

21. A trim part for a vehicle, comprising:
at least one light-emitting textile with a textile layer having at least one light guide with a casing.
wherein at least one light exit region is created with a method according to claim 11.

22. A vehicle comprising:
the trim part according to claim 21.
